(19) United States
(12) Patent Application Publication
(10) Pub. No.: US 2010/0070567 A1
(43) Pub. Date: Mar. 18, 2010

(54) Information processing apparatus, delivery system, and processing control method

(75) Inventor: Takehiro Kamata, Saitama (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/461,994

(22) Filed: Aug. 31, 2009

(30) Foreign Application Priority Data
Sep. 17, 2008 (JP) 2008-238558

(51) Int. Cl. G06F 15/16; G06F 17/30

(52) U.S. Cl. 709/203; 707/E17.001

(57) ABSTRACT

A deliver server includes a project flow database that stores therein project flow data that is obtained by associating a flow of one or more processes performed on delivery data with an identifier for setting data for use in the processes, a setting data database that stores therein the setting data using a predetermined hierarchical structure, a parameter setting unit that sets and updates the setting data, and a flow-execution control unit that controls executions of the one or more processes performed on the delivery data based on the project flow data and the setting data. The parameter setting unit reads, when performing setting on setting data for a lower hierarchy than a most significant hierarchy, setting data for an upper hierarchy than the lower hierarchy from the setting data database and hands over the read setting data to the lower hierarchy for inheritance.

### CROSS-REFERENCE TO RELATED APPLICATIONS

The present application claims priority to and incorporates by reference the entire contents of Japanese Patent Application No. 2008-238558 filed in Japan on Sep. 17, 2008.

### BACKGROUND OF THE INVENTION

1. Field of the Invention

The present invention relates to an information processing apparatus that manages set values in a processing program, a delivery system that uses the information processing apparatus, a processing control method, and a computer program product.

2. Description of the Related Art

In recent years, many companies have a high tendency to connect image input-output devices such as multifunction products to a network. The image input-output device largely plays the role of a means for planning the efficiency of a business. A delivery management system that effectively computerizes and distributes paper documents is important. The delivery management system includes an image input device (scanner) and a delivery management server. The delivery management server previously registers therein a plurality of delivery processing menus tailored to various businesses and applications. A user selects a processing menu suitable for a business from the operation panel (operating unit) of the scanner and uses a scanner to perform a scan.

An information processing apparatus disclosed in Japanese Patent Application Laid-open No. 2008-97586 associates bibliographic information input from a bibliographic information inputting screen displayed on a multifunction product based on screen definition data with flow definition data and performs one or a plurality of processes on scan image data based on the flow definition data associated with the bibliographic information. Using this technique, a business flow can be defined flexibly and carefully.

The problem is that it is not assumed in the conventional art that the set values (parameters) of the business flow are hierarchically managed. Therefore, for example, when the set value of the business flow in an upper hierarchy is changed, in the conventional art the change is not reflected in the business flow in a lower hierarchy.

### SUMMARY OF THE INVENTION

It is an object of the present invention to at least partially solve the problems in the conventional technology.

According to an aspect of the present invention, there is provided an information processing apparatus that controls a delivery process in a delivery system that delivers delivery data. The information processing apparatus including a first storage unit configured to store therein project flow data that contain an association of a flow of one or more processes performed on the delivery data with an identifier for setting data for use in the processes; a second storage unit configured to store therein contents of the setting data in a predetermined hierarchical structure; a communication unit configured to control transmission and reception of the delivery data and other types of data; a parameter setting unit configured to set and update contents of the setting data; and a flow-execution control unit configured to control executions of the one or more processes performed on the delivery data based on the project flow data and the setting data. When setting setting data of a lower hierarchy than a most significant hierarchy, the parameter setting unit reads setting data for an upper hierarchy than the lower hierarchy from the second storage unit and hands over read setting data to the lower hierarchy for inheritance.

According to another aspect of the present invention, there is provided a delivery system including an information processing apparatus and an image forming apparatus that supplies the delivery data to the information processing apparatus. The information processing apparatus controls a delivery process to be performed on data received from the image forming apparatus. The information processing apparatus includes a first storage unit configured to store therein project flow data that contain an association of a flow of one or more processes performed on delivery data with an identifier for setting data for use in the processes; a second storage unit configured to store therein contents of the setting data in a predetermined hierarchical structure; a communication unit configured to control transmission and reception of the delivery data and other types of data; a parameter setting unit configured to set and update contents of the setting data; and a flow-execution control unit configured to control executions of the one or more processes performed on the delivery data based on the project flow data and the setting data. When setting setting data of a lower hierarchy than a most significant hierarchy, the parameter setting unit reads setting data for an upper hierarchy than the lower hierarchy from the second storage unit and hands over read setting data to the lower hierarchy for inheritance.

According to still another aspect of the present invention, there is provided a processing control method in an information processing apparatus that controls a delivery process in a delivery system that delivers delivery data. The information processing apparatus includes a first storage unit configured to store therein project flow data that contain an association of a flow of one or more processes performed on the delivery data with an identifier for setting data for use in the processes; and a second storage unit configured to store therein contents of the setting data in a predetermined hierarchical structure. The processing control method includes upon detecting an operation for setting setting data of a lower hierarchy than a most significant hierarchy, reading setting data for an upper hierarchy than the lower hierarchy from the second storage unit and handing over read setting data to the lower hierarchy for inheritance.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a network configuration example of a delivery system according to an embodiment of the present invention;

FIG. 2 is a conceptual diagram illustrating a hierarchical setting structure;

FIG. 3 is a conceptual diagram illustrating a relationship between a multifunction product and a set of a profile, a project, and a service according to the present embodiment;

FIG. 4 is a block diagram illustrating a configuration example of a delivery server;

FIG. 5 is a diagram illustrating an example of a system-level setting screen;

FIG. 6 is a diagram illustrating an example of an XML source for the setting screen illustrated in FIG. 5;

FIG. 7 is a diagram illustrating an example of setting data at a system level;

FIG. 8 is a diagram illustrating an example of a setting screen other than the most significant hierarchy;

FIG. 9 is a diagram illustrating an example of setting data at a profile level;

FIG. 10A is a diagram illustrating a typical example of a project flow;

FIG. 10B is a diagram illustrating a typical example of the project flow;

FIG. 10C is a diagram illustrating a typical example of the project flow;

FIG. 11 is a conceptual diagram illustrating a hierarchical setting structure when taking into consideration the project flow;

FIG. 12 is a sequence diagram illustrating a delivery process in the delivery system illustrated in FIG. 1;

FIG. 13 is a diagram illustrating an example of setting data;

FIG. 14 is a diagram illustrating an example in which the system-level setting data is changed; and

FIG. 15 is a diagram illustrating an example of setting data.

### DETAILED DESCRIPTION OF THE PREFERRED EMBODIMENTS

Exemplary embodiments of the present invention will be explained in detail below with reference to the accompanying drawings. However, the present invention is not limited to these embodiments.

In the embodiments explained below, the information processing apparatus, the delivery system, the processing control method, and the computer program product are applied to a delivery server, a delivery system, a delivery process control method, and a delivery process control program, in which the delivery server delivers image data scanned by a multifunction product. However, the information processing apparatus, the delivery system, the processing control method, and the computer program product of the present invention are not limited to them and can be applied to any apparatus or system if this controls a process for image data.

In the embodiments described below, it will be explained about a multifunction product, which realizes a printer function, a scanner function, a copy function, and a facsimile function, as an example of an image forming apparatus that inputs image data. However, the present invention is not limited to the multifunction product and can be applied to any of a scanner, a facsimile machine, a copier, and so on if they are an image forming apparatus that can input image data.

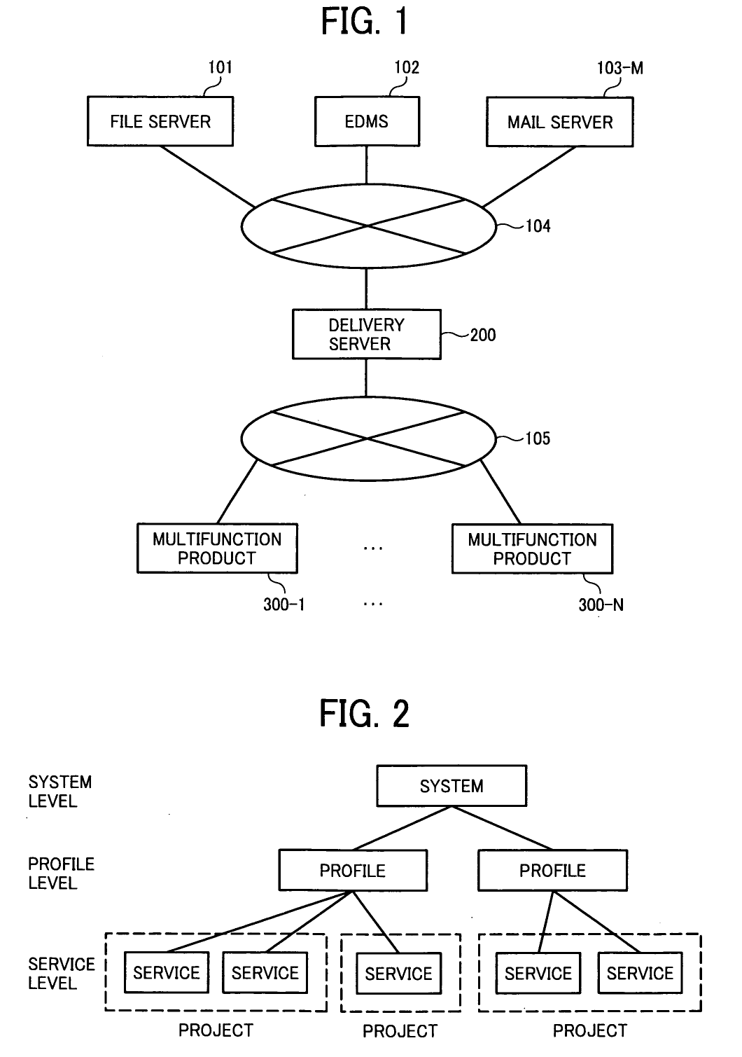

FIG. 1 is a diagram illustrating a network configuration example of a delivery system according to an embodiment of the present invention. The delivery system illustrated in FIG. 1 includes a delivery server 200 connected to a network 104 such as LAN or Internet, a file server 101 connected to the network 104, an EDMS (Enterprise Document Management System) 102 and mail (email) servers 103-M (M=1, 2,. . . ), and multifunction products 300-N (N=1, 2,. . . ) connected to a network 105 such as LAN or the Internet.

The multifunction product 300-N is an apparatus that together has a scan function, a copy function, a printer function, a facsimile function, and so on. The multifunction product 300-N scans a paper medium by using the scan function to generate image data and sends the generated image data to the delivery server 200. The multifunction product 300-N includes a communication unit, a scanning application for using the scanner function, and an operation panel that has a display unit, an operating unit, and so on.

The delivery server 200 is a computer such as a workstation that receives the image data scanned by the multifunction product 300-N and performs various processes and delivery processes on the image data in accordance with a project flow (described later).

The file server 101 is a computer that accumulates and manages files that are shared on the network 104. The EDMS 102 is a so-called document management system. The mail server 103-M is a server that sends electronic mails based on SMTP that is a mail delivery protocol. The file server 101, the EDMS 102, and the mail server 103-M are accessed by the delivery server 200 for its delivery process.

Processes constituting a business flow in the present embodiment are defined to operate by separate computer programs. Each process is performed by a plug-in system for the delivery system. The computer program includes, for example, a mail delivery program, a file sending program, and an image conversion program. The virtual entity of such a computer program is called as a “service” that is a process corresponding to a unit constituting the business flow. In this case, a plurality of services having different setting can be defined by using the same program.

First, it will be explained about the management of setting data in the delivery system illustrated in FIG. 1. The setting data is data indicating setting contents (parameters). FIG. 2 is a conceptual diagram illustrating a hierarchical setting structure. As shown in FIG. 2, the hierarchical setting structure can be divided into three stages: a system level, a profile level, and a service level. As described above, a service belongs to the lowest hierarchy because the service is a process acting as a unit. A business flow obtained by combining one or more services is called as a project. A profile is a set of one or more projects. Such a hierarchical structure exists for each plug-in program.

In the hierarchical structure, setting is performed on each of the three levels. At this time, an upper hierarchy manages default values of a lower hierarchy that is at a lower hierarchy level than the upper hierarchy. In other words, a system located at a system level manages default values of profiles located at a lower hierarchy. Moreover, a profile located at a profile level manages default values of services located at a lower hierarchy than the profile level. In other words, a profile (projects included in the profile) can inherit setting contents for a system that belongs to an upper hierarchy than the profile. Moreover, each service can inherit setting contents for a profile that belongs to an upper hierarchy than the service.

The setting (setting contents) indicates communication setting such as addresses of the mail server and the file server, a port number, or a certificate for security-enhancement communication. Moreover, the setting indicates activity setting such as file attachment setting when delivering mails, setting for describing only URL of the file server, or PDF conversion setting when performing image conversion.

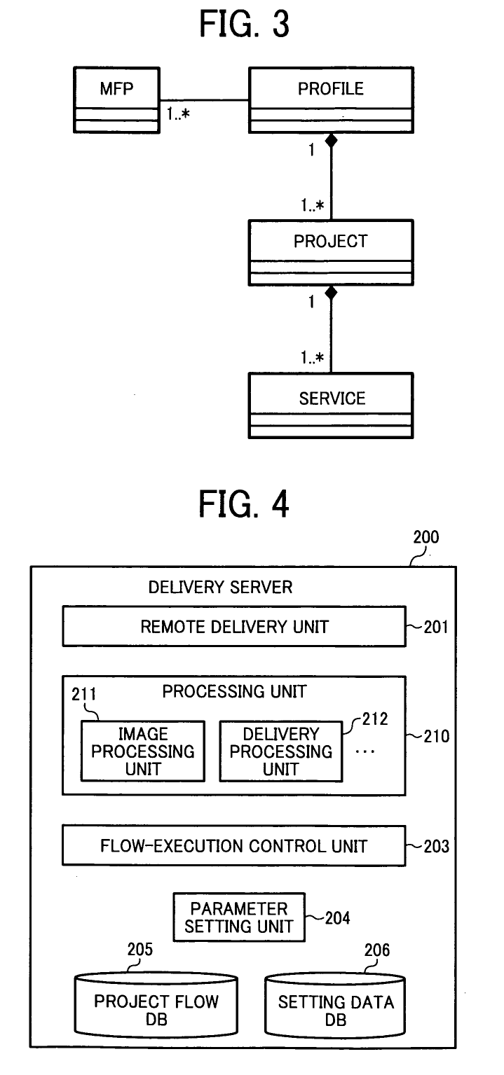

The delivery system according to the present embodiment includes the plurality of multifunction products 300-N as illustrated in FIG. 1. FIG. 3 is a conceptual diagram illustrating a relationship between the multifunction product and a set of the profile, the project, and the service according to the present embodiment. As illustrated in FIG. 3, one multifunction product corresponds to only one profile. Conversely, one profile can be assigned to the plurality of multifunction products (one profile: one or more multifunction products). In this manner, because one profile is assigned to the plurality of multifunction products, projects (business flows) managed by the one profile can be executed by the plurality of multifunction products. From the standpoint of a multifunction product, because one or more projects belonging to a profile are assigned to one multifunction product, a plurality of projects (services) can be executed by one multifunction product (one multifunction product: one or more projects, one or more services). For example, services that are defined by the same program and have different parameters are registered in separate projects and these projects are registered in the same profile. If this profile is assigned to the same multifunction product, one multifunction product can execute services of which the business flows are the same and the parameters (sending destination and save destination) are different.

The delivery system separately manages a flow and setting of each process. Therefore, a service and a project are generated when setting contents are provided to flows.

FIG. 4 is a block diagram illustrating a configuration example of the delivery server 200. The delivery server 200 includes a remote delivery unit 201, a processing unit 210, a flow-execution control unit 203, a parameter setting unit 204, a project flow database 205, and a setting data database 206.

The remote delivery unit 201 receives a service execution command from each multifunction product and sends various types of data to the file server 101, the EDMS 102, and the mail server 103-M.

The processing unit 210 includes an image processing unit 211 and a delivery processing unit 212 and executes services defined by a project. The image processing unit 211 performs image processing such as image data conversion. The delivery processing unit 212 delivers image data to the file server 101, the EDMS 102, the mail server 103-M, and the multifunction products 300-1 to 300-N.

The flow-execution control unit 203 reads a project flow (described later) from the project flow database 205 and reads setting data for each service included in the project flow from the setting data database 206. The flow-execution control unit 203 controls the processing unit 210 based on the data to execute various types of processes. Moreover, the flow-execution control unit 203 saves a profile assignment table that associates each of the multifunction products 300-1 to 300-N with an identifier of a profile assigned to each multifunction product.

The parameter setting unit 204 generates or edits setting data in accordance with an instruction of a system administrator of the delivery server 200 and saves the result in the setting data database 206.

The project flow database 205 contains project flows. A project flow is data defined for a flow among processes performed on image data that is scanned and transmitted by the multifunction product 300-N. The project flow defines services included in the project and an execution sequence of the services. In this case, the project flow is predefined and saved. The setting data database 206 saves setting data for a system level, a profile level, and a service level. Moreover, the setting data database 206 saves a setting hierarchy management table that manages the setting data for the profile level, the project level, and the service level with conditions. The project flow database 205 and the setting data database 206 are storage medium such as HDD (hard disk drive).

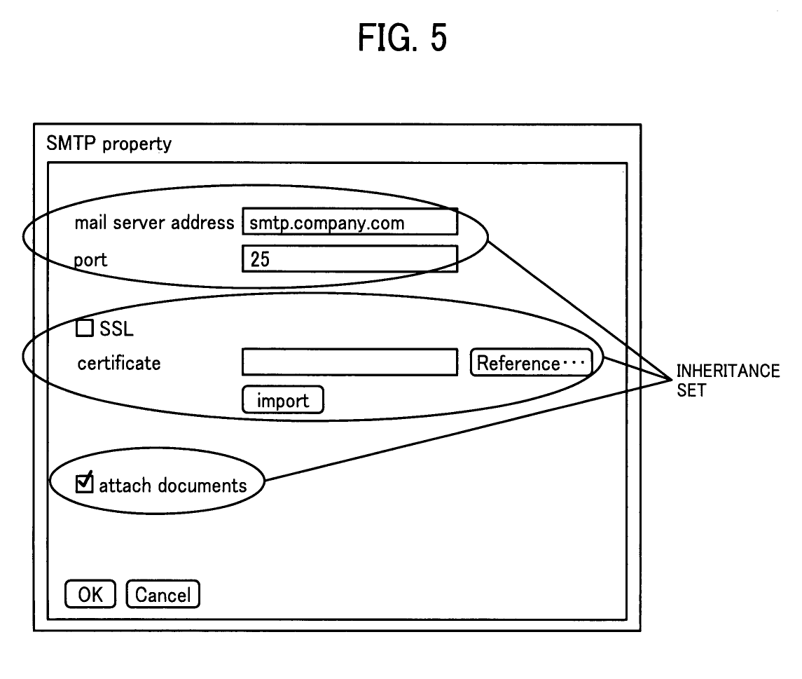

Next, it will be explained about details of setting data and setting operations using a mail delivery service as an example. FIG. 5 is a diagram illustrating an example of a system-level setting screen. For example, in FIG. 5, the mail delivery service includes setting items such as mail server address, port number, selecting whether security communication is performed, certificate when performing security communication, whether a document is attached to a body text. In this case, for example, {mail server address, port number} is defined as one inheritance set, {selecting whether security communication is performed, certificate when performing security communication} is defined as one inheritance set, and {whether a document is attached to a body text} is defined as one inheritance set.

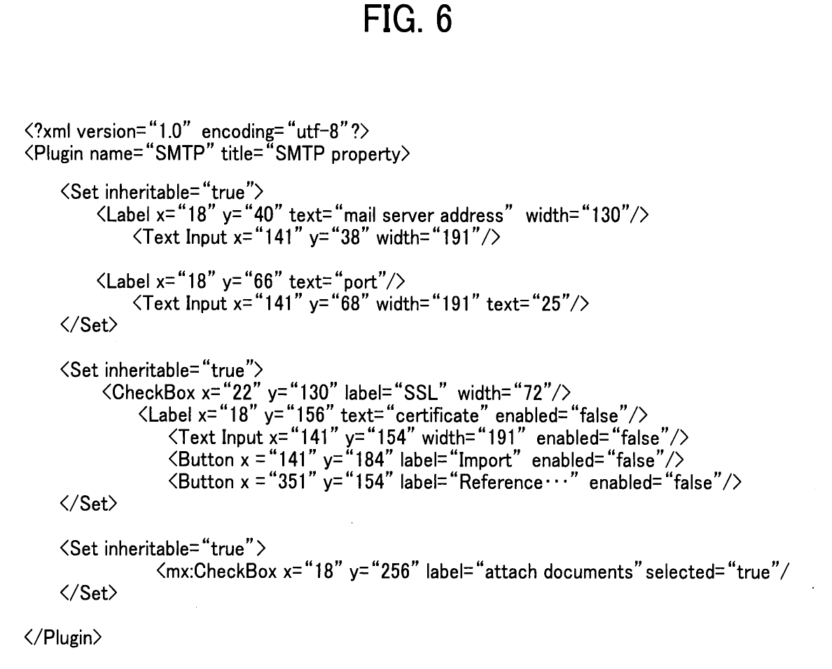

FIG. 6 is a diagram illustrating an example of an XML source for the setting screen illustrated in FIG. 5. In the XML source illustrated in FIG. 5, each of mail server address, port number, selecting whether security communication is performed, certificate when performing security communication, whether a document is attached to a body text that are above defined as an inheritance set is described as a sub-element of an element called <Set>. The attribute of each <Set> element is described as “inheritable=“true””. Because of “inheritable=“true””, the setting item can be inherited from the upper hierarchy than that of the item. When it is requested that a part or all of the setting items are not inherited, the setting items are not described as the sub-elements of the <Set> element or the attributes of sub-elements are defined as “inheritable=“false”” in a state where the setting items are described as the sub-elements of the <Set> element. Even when any setting screen of a system level, a profile level, and a service level is generated, the XML source illustrated in FIG. 5 can be used.

Next, it will be explained about the case when the system-level setting for the mail delivery service is performed on the delivery server 200 by using the screen illustrated in FIG. 5. When the system administrator operates the system-level setting for the mail delivery service with respect to the delivery server 200, the parameter setting unit 204 of the delivery server 200, which detects this operation, reads an XML source saved therein and causes the display unit to display a setting screen. In this case, in a system-level setting process, the attribute of the <Set> item described above is ignored when the screen is generated.

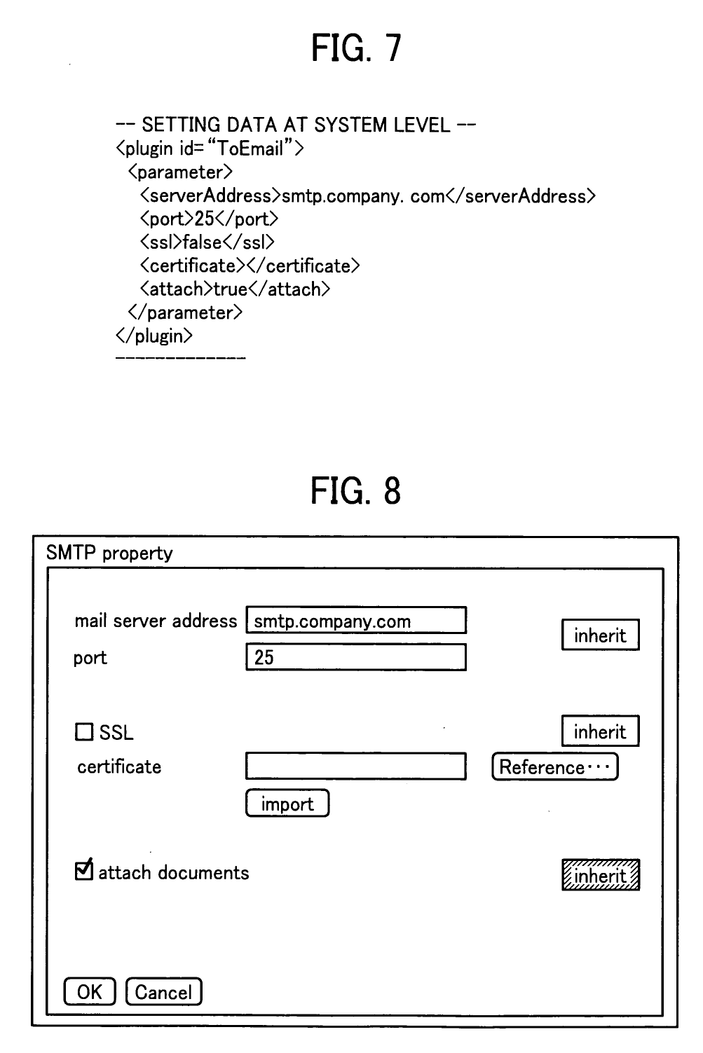

The system administrator inputs the setting contents like an input example displayed on the setting screen illustrated in FIG. 5 and sets the setting contents in concrete. For example, “smtp.company.com” is entered in the field “mail server address”, “25” is entered in the field “port number”, and a check is made in the field “whether a document is attached to a body text” (that is to say, a document is attached to a body text). A check is not made in the fields “selecting whether security communication is performed” and “certificate when performing security communication”. When the input is set in concrete, the parameter setting unit 204 of the delivery server 200 saves the input contents in the setting data database 206 as setting data at the system level of “mail delivery”. FIG. 7 is a diagram illustrating an example of setting data at the system level. In this manner, the input values of setting items are maintained between a <parameter> tag and a </parameter> tag.

Next, it will be explained about the case when the setting is performed at the profile level that belongs to a lower hierarchy than the system level. When the system administrator operates the profile-level setting for the mail delivery service with respect to the delivery server 200, the parameter setting unit 204 of the delivery server 200, which detects this operation, causes the display unit to display a setting screen. FIG. 8 is a diagram illustrating an example of the setting screen other than the most significant hierarchy. FIG. 8 is different from FIG. 5 from the standpoint of the display of icon. When the setting screen other than the most significant hierarchy is displayed, a computer program (function) that performs the generation of screen in the parameter setting unit 204 reads the XML source of FIG. 6 and refers to the attribute of the <Set> item. Then, when “inheritable=true”, the computer program causes the display to display an icon (a selection icon) for each inheritance set. In the setting screen of FIG. 8, whether high-order setting contents are inherited can be selected by operating the selection icon displayed for each inheritance set. Moreover, when generating the screen, the parameter setting unit 204 reads setting data at a high-order system level in the “mail delivery” computer program from the setting data database 206 and sets each value to a field corresponding to each setting item. In FIG. 8, each value of system-level setting data as illustrated in FIG. 7 is displayed as a default value of each setting item.

For example, the setting screen illustrated in FIG. 8 has the same input values (or default values) as those illustrated in FIG. 5. Then, the system administrator clicks a selection icon that is present near “whether a document is attached to a body text” to select that the set value of a higher-order hierarchy is not inherited for the item. In FIG. 8, to indicate the selected state of inheritance, the icon has been hatched. The system administrator sets the input to the screen contents in concrete. When the input is set in concrete, the parameter setting unit 204 of the delivery server 200 saves the input contents as setting data of “mail delivery” at the profile level as described above.

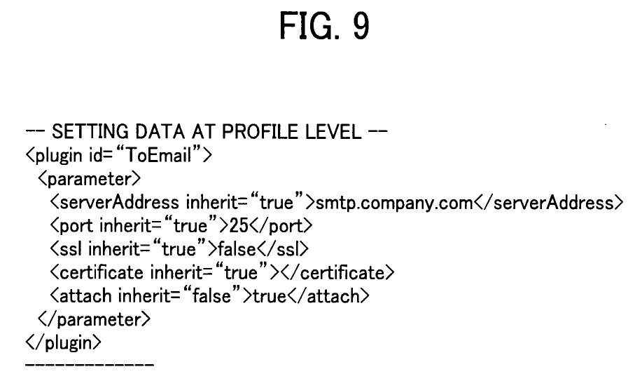

FIG. 9 is a diagram illustrating an example of the setting data at the profile level. When the setting data illustrated in FIG. 9 are compared with the setting data illustrated in FIG. 7, the difference is that the states of the selection icons are reflected for all setting items, in other words, “inherit=“true”” or “inherit=“false”” is described. As input in the setting screen illustrated in FIG. 8, the attribute of “whether a document is attached to a body text” (<attach>) illustrated in FIG. 9 is not inherited (“inherit=“false””). Whether or not the set value of the higher-order hierarchy is inherited is determined by only the state of the selection icon. Therefore, when “to inherit” is selected by operating the selection icon, the attribute of the setting item is saved as “inherit=“true”” even if the input value of the setting item is changed from a default value. Conversely, when “not to inherit” is selected as illustrated in FIG. 8, the attribute of the setting item is saved as “inherit=“false”” as described above even in the state where the input values of the setting items are default values.

When the setting for the service level that has a lower hierarchy than the profile level is performed, the set values for the profile level that is the higher-order hierarchy are displayed as default values similarly to the case when the setting for the profile level is performed. Moreover, an icon is displayed near each inheritance set. Therefore, it is possible to select whether high-order setting contents are inherited.

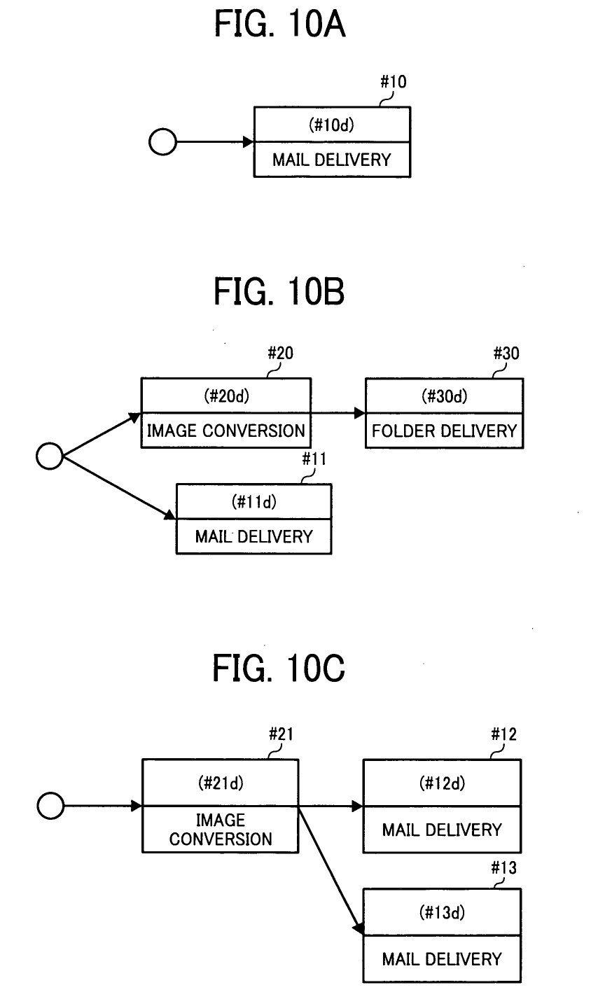

Next, it will be explained about delivery operations performed in the delivery system configured as described above by using a specific project flow as an example. FIGS. 10A to 10C are diagrams illustrating typical examples of the project flow. It is defined that a flow illustrated in FIG. 10A is a project flow #1, a flow illustrated in FIG. 10B is a project flow #2, and a flow illustrated in FIG. 10C is a project flow #3. Hereinafter, a service, which designates an identifier of setting data for a program of defining operations, and setting data (the addition of d (data)) are described.

The project flow #1 consists of only mail delivery service #10 (setting data #10d). When the project flow #1 is executed, the setting data #10d is read and mail delivery is performed in accordance with the setting contents. The project flow #2 consists of three services of an image conversion service #20 (setting data #20d), a mail delivery service #11 (setting data #11d), and a folder sending service #30 (setting data #30d). When the project flow #2 is executed, as illustrated in FIG. 10B, the setting data #20d is read to convert an image, and then the setting data #30d is read to perform folder delivery. Moreover, in parallel with these processes, the setting data #11d is read to perform mail delivery without performing image conversion. Furthermore, the project flow #3 consists of three services of an image conversion service #21 (setting data #21d), a mail delivery service #12 (setting data #12d), and a mail delivery service #13 (setting data #13d). When the project flow #3 is executed, the setting data #21d is first read to perform image conversion as illustrated in FIG. 10C. Next, the setting data #12d is read to perform mail delivery. Concurrently, the setting data #13d is read to perform mail delivery. These project flows are saved in the project flow database 205.

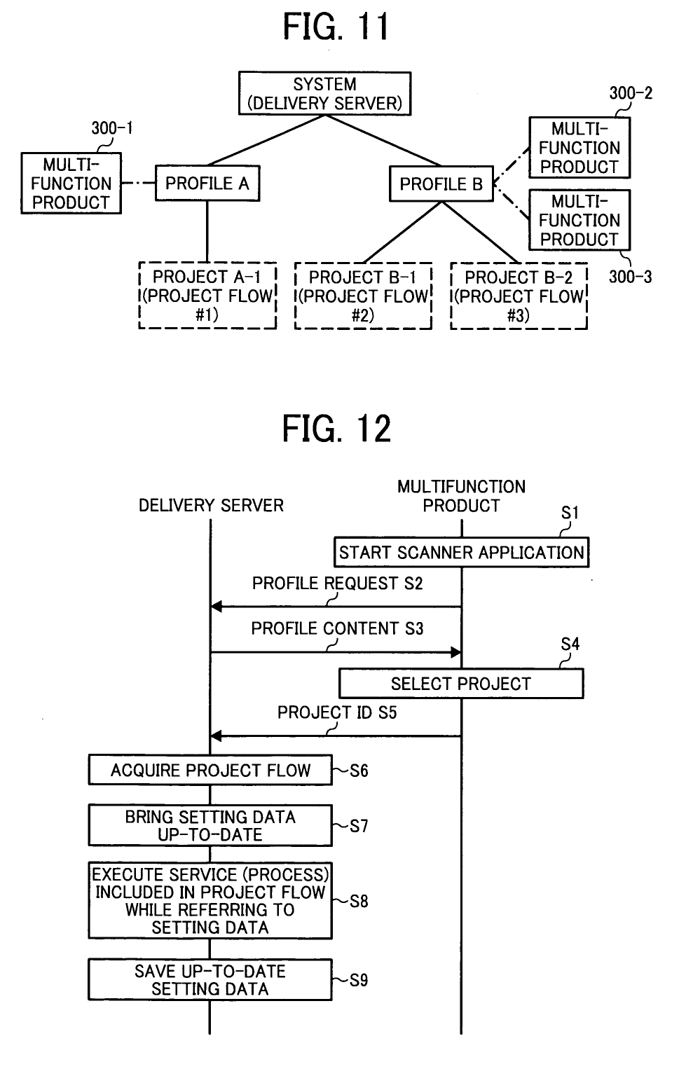

FIG. 11 is a conceptual diagram illustrating a hierarchical setting structure when taking into consideration the project flows #1 to #3. As illustrated in FIG. 11, a profile A and a profile B are registered in a system (the delivery server 200). A project A-1 is registered in the profile A and a project B-1 and a project B-2 are registered in the profile B. The project A-1 corresponds to the project flow #1, the project B-1 corresponds to the project flow #2, and the project B-2 corresponds to the project flow #3. In this case, the profile A is assigned to the multifunction product 300-1 and the profile B is assigned to the multifunction products 300-2 and 300-3. Therefore, the multifunction product 300-1 can the project A-1 (the project flow #1). The multifunction products 300-2 and 300-3 can execute the project B-1 (the project flow #2) and the project B-2 (the project flow #3).

FIG. 12 is a sequence diagram illustrating a delivery process in the delivery system illustrated in FIG. 1. It will be explained about the case when the multifunction product 300-2 is operated. First, when a user clicks a scan button on an operating unit of an operation panel of the multifunction product 300-2, a scanner application of the multifunction product 300-2 is started by the detection of the click (Step S1). The scanner application sends the request for the profile (profile request) that can be executed in the multifunction product 300-2 to the delivery server 200 via a communication unit (Step S2). When the flow-execution control unit 203 of the delivery server 200 receives the request for the profile via the remote delivery unit 201, the flow-execution control unit 203 refers to the profile assignment table saved therein and acquires the profile (the profile B) assigned to the multifunction product 300-1. Then, the flow-execution control unit 203 refers to the hierarchy management table by using the acquired profile B as a key and identifies all the projects (the projects B-1 and B-2) that belong to a lower hierarchy than the profile B. Then, the flow-execution control unit 203 sends the selection screen on which the projects B-1 and B-2 are displayed or the data of the selection screen to the multifunction product 300-2 as the contents of the profile B (profile content) (Step S3). The selection screen (or the data) includes the identifiers of the projects B-1 and B-2.

The multifunction product 300-2 causes the display unit of the operation panel to display the received selection screen. The user operates the operating unit to select a desired project from the profile B displayed on the display unit. As an example, the user selects the project B-1 (Step S4). Moreover, the user inputs additional information such as a mail address of a mail delivery destination or a save-destination folder of folder delivery as fine information other than the setting data. When all the necessary data are set in concrete, the scanner application of the multifunction product 300-2 scans the manuscript provided by the user. Then, the communication unit of the multifunction product 300-2 sends the identifier of the project B-1 (project ID) selected by the user, the input additional information, and the scanned data to the delivery server 200 (Step S5).

When the flow-execution control unit 203 of the delivery server 200 receives the identifier of the project B-1, the additional information, and the scanned data via the remote delivery unit 201, the flow-execution control unit 203 accesses the project flow database 205 and acquires the project flow #2 of the project B-1 corresponding to the received identifier (Step S6). In this case, the project flow #2 consists of three services: the image conversion service #20 (the setting data #20d), the mail delivery service #11 (the setting data #11d), and the folder sending service #30 (the setting data #30d). Therefore, the flow-execution control unit 203 executes the image conversion program in accordance with the setting data #20d and then executes the folder delivery program in accordance with the setting data #30d. Moreover, the flow-execution control unit 203 executes the mail delivery program in accordance with the setting data #11d. For this purpose, the flow-execution control unit 203 first reads the setting data #11d, #20d, and #30d from the setting data database 206.

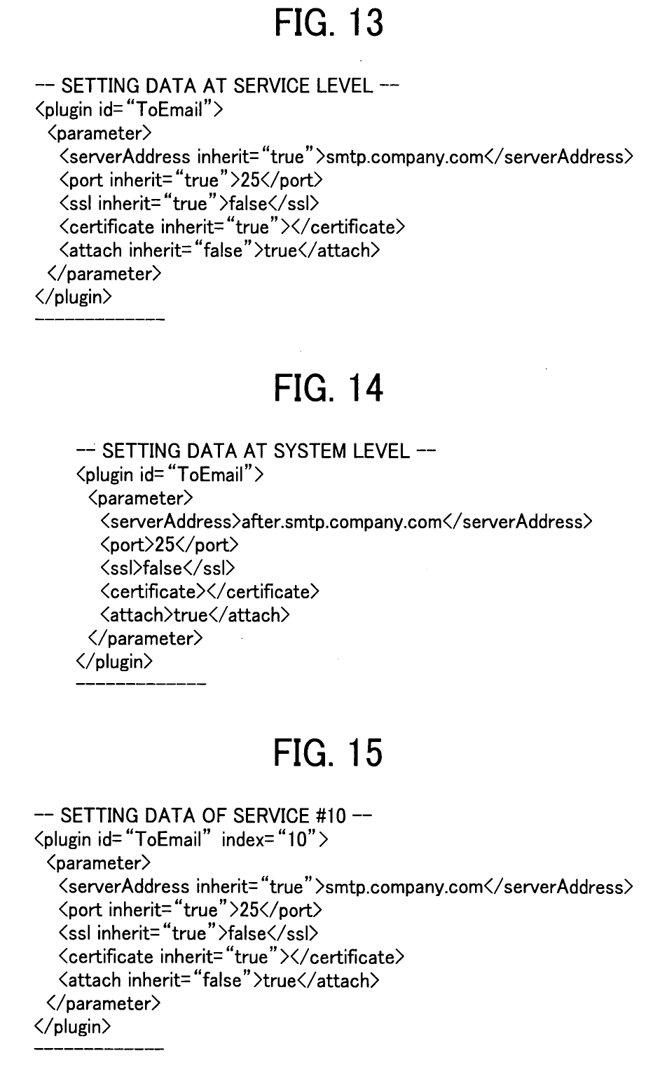

Hereinafter, the setting data #11d will be explained as an example. FIG. 13 is a diagram illustrating an example of the setting data #11d. In FIG. 13, the setting data #11d includes an item whose the attribute is “inherit=“true””. Therefore, the flow-execution control unit 203 refers to the setting hierarchy management table in the setting data database 206 and specifies the setting data for the upper hierarchies (the profile level and the system level) than that of the setting data #11d. Then, the flow-execution control unit 203 first refers to the setting data for the profile level for the item. When the attribute of the item referred to at the profile level is “inherit=“true””, the flow-execution control unit 203 further refers to the setting data for the system level and acquires the value of the item of the system level. On the other hand, when the attribute of the item referred to at the profile level is “inherit=“false””, the flow-execution control unit 203 acquires the value of the item of the profile level because system-level setting contents are not inherited. Then, the flow-execution control unit 203 replaces the item whose the attribute is “inherit=“true”” for the setting data #11d by the acquired values. In this case, because setting from the system level to the service level is the same, the replacement is not performed for the value. In this way, the flow-execution control unit 203 changes the setting data #11d into the latest state (Step S7). The flow-execution control unit 203 similarly changes the setting data #20d and #30d into the latest state.

The flow-execution control unit 203 performs a process while handing over the setting data to the function unit of the processing unit 210 in a sequence described in the project flow #2. For example, the flow-execution control unit 203 hands over the setting data #11d, the received additional information, and the scanned data to the delivery processing unit 212 in the processing unit 210, which processes a mail delivery service, and instructs the delivery processing unit 212 to execute a mail delivery program. The delivery processing unit 212 executes for the scanned data the mail delivery program saved therein while referring to the setting data #11d and the additional information (Step S8). In this way, the mail delivery service #11 is executed. In parallel with this, the flow-execution control unit 203 similarly instructs the image processing unit 211 to execute an image conversion program. The image processing unit 211 executes for the scanned data the image conversion program saved therein while referring to the setting data #20d and the additional information. When receiving the completion report for the image conversion service #20 from the image processing unit 211, the flow-execution control unit 203 similarly instructs the delivery processing unit 212 to execute a folder delivery program. The delivery processing unit 212 executes, for the scanned data on which image conversion is performed, the folder delivery program saved therein while referring to the setting data #30d and the additional information (Step S8). In this way, the image conversion service #20 and the folder delivery service #30 are executed.

As described above, the project flow #2 is executed. Specifically, the scanned data are delivered by mail to the mail server that is designated by the setting data #11d. For example, the data are delivered by mail to a mail server 103-1. Also, image conversion (for example, PDF conversion) designated by the setting data #20d is performed on the scanned data. After that, the converted data are delivered by folder to the file server designated by the setting data #30d. For example, the data are delivered by folder to the file server 101. Moreover, the flow-execution control unit 203 saves the latest setting data in the setting data database 206 (Step S9).

Next, it will be explained about delivery operations after system-level setting is changed when the change is reflected in a lower hierarchy.

The system administrator or the like of the delivery server 200 changes system-level setting of the mail delivery service by using the setting screen. In this way, the setting data are changed from the contents illustrated in FIG. 7 to the contents illustrated in FIG. 14. FIG. 14 is a diagram illustrating an example in which the system-level setting data is changed. When comparing FIG. 14 with FIG. 7, the setting of the mail server <serverAddress> is changed from “smtp.company.com” to “after.smtp.company.com”.

In this case, it will be explained about the case when the user operates the multifunction product 300-1. As described above, when the processes of Steps S1 and S2 are performed, the flow-execution control unit 203 of the delivery server 200 refers to the profile assignment table saved therein and acquires the profile (the profile A) assigned to the multifunction product 300-1. Then, the flow-execution control unit 203 refers to the hierarchy management table by using the obtained profile A as a key and specifies all projects (the project A-1) that belong to the lower hierarchy than the profile A. Then, the flow-execution control unit 203 sends the selection screen on which the project A-1 is displayed or the data of the selection screen to the multifunction product 300-1 as the contents of the profile A (Step S3).

The multifunction product 300-1 makes the display unit of the operation panel display the received selection screen. The user operates the operating unit to select the project A-1 included in the profile A displayed on the display unit (Step S4). After that, similarly to the above, the process of Step S5 is performed. Next, when the flow-execution control unit 203 receives the identifier of the project A-1, the additional information, and the scanned data via the remote delivery unit 201, the flow-execution control unit 203 accesses the project flow database 205 and acquires the project flow #1 of the project A-1 by using the received identifier as a key (Step S6). In this case, the project flow #1 consists of only the mail delivery service #10 (the setting data #10d). Therefore, it is only necessary to execute the mail delivery program in accordance with the setting data #10d. The flow-execution control unit 203 reads the setting data #10d from the setting data database 206.

FIG. 15 is a diagram illustrating an example of the setting data #10d. In FIG. 15, the setting data #10d includes an item of which the attribute is “inherit=“true””. Therefore, similarly to the above, the flow-execution control unit 203 refers to the setting data for the upper hierarchy (the profile level and the system level) than that for the setting data #10d. In this case, in the setting data #10d, the system-level setting data of <serverAddress> that is “inherit=“true”” is changed. Because the setting data is different from that of the service level, the value of <serverAddress> of the setting data #10d is replaced (Step S7). After that, similarly to the above, the flow-execution control unit 203 controls the execution of the project flow #1 (Step S8) and saves the latest setting data #10d in the setting data database 206 (Step S9).

As described above, in the present embodiment, setting data used in each process that is executed in a delivery system are managed hierarchically and a lower hierarchy can inherit the setting contents for an upper hierarchy. In this way, management can be performed easily and precisely even if'setting is complicated. Therefore, the burden of the system administrator can be reduced and the system error can be reduced. Moreover, in the present embodiment, the lower hierarchy cannot inherit the setting contents for the upper hierarchy. In this way, fine setting becomes possible. When performing the process for the lower hierarchy, the upper-hierarchy data can be referred to for the item for which the upper-hierarchy data are inherited. Therefore, because the lower-hierarchy setting is automatically updated at the timing of the execution of the process when the upper-hierarchy setting is changed, it is possible to avoid a management burden under which the lower-hierarchy setting is manually changed point by point.

The delivery server 200 according to the present embodiment includes a control device such as a CPU, a storage device such as a ROM (Read Only Memory) or a RAM, an external storage device such as an HDD or a CD drive, a display such as a display unit, and an input device such as a keyboard or a mouse. The delivery server 200 has a hardware configuration of a normal computer.

A processing control program executed in the delivery server of the present embodiment is recorded as a file having a format that can be installed or executed in a recording medium, which can be read by the computer, such as a CD-ROM, a flexible disk (FD), a CD-R, or a DVD (Digital Versatile Disk), and is provided to the user.

Furthermore, the processing control program executed in the delivery server 200 of the present embodiment can be stored on a computer connected to a network such as the Internet and can be provided to the user by download through the network. Moreover, the processing control program executed in the delivery server 200 of the present embodiment can be provided or distributed through a network such as Internet.

Moreover, the processing control program executed in the delivery server 200 of the present embodiment can be provided or distributed in a format incorporated in the ROM.

The processing control program executed in the delivery server 200 of the present embodiment has a module configuration including the remote delivery unit, the processing unit, the flow-execution control unit, and the parameter setting unit as described above. From the viewpoint of actual hardware, the CPU (processor) reads the program from the ROM to load the remote delivery unit, the processing unit, the flow-execution control unit, and the parameter setting unit on a main memory so that the units are generated on the main memory.

A processing control method implemented on a delivery system including an information processing apparatus that controls a delivery process on data and an image forming apparatus that supplies delivery data to the information processing apparatus, wherein
the information processing apparatus includes
   a first storage unit configured to store therein project flow data that contain an association of a flow of one or more processes performed on the delivery data with an identifier for setting data for use in the processes; and
   a second storage unit configured to store therein contents of the setting data in a predetermined hierarchical structure,
wherein the processing control method includes the information processing apparatus performing
   controlling transmission and reception of the delivery data and other types of data;
   setting and updating contents of the setting data; and
   controlling executions of the one or more processes performed on the delivery data based on the project flow data and the setting data, wherein
   the setting and updating includes, upon detecting an operation for setting setting data of a lower hierarchy than a most significant hierarchy, reading setting data for an upper hierarchy than the lower hierarchy from the second storage unit and handing over read setting data to the lower hierarchy for inheritance.

As described above, according to an aspect of the present invention, it is possible to easily manage a set value in a processing program.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus that controls a delivery process in a delivery system that delivers delivery data, the information processing apparatus comprising:
a first storage unit configured to store therein project flow data that contain an association of a flow of one or more processes performed on the delivery data with an identifier for setting data for use in the processes;
a second storage unit configured to store therein contents of the setting data in a predetermined hierarchical structure;
a communication unit configured to control transmission and reception of the delivery data and other types of data;
a parameter setting unit configured to set and update contents of the setting data; and
a flow-execution control unit configured to control executions of the one or more processes performed on the delivery data based on the project flow data and the setting data, wherein
when setting setting data of a lower hierarchy than a most significant hierarchy, the parameter setting unit reads setting data for an upper hierarchy than the lower hierarchy from the second storage unit and hands over read setting data to the lower hierarchy for inheritance.

2. The information processing apparatus according to claim 1, wherein the parameter setting unit
displays a setting screen on which the setting data for the upper hierarchy is displayed as a default value when the setting data for the upper hierarchy is handed over to the lower hierarchy and a selection icon for selecting whether the setting data for the upper hierarchy is handed over is displayed; and
saves, in the second storage unit, the setting data for the lower hierarchy deterministically input by a user and information indicating whether the setting data for the upper hierarchy is handed over.

3. The information processing apparatus according to claim 2, wherein
the selection icon can be operated repeatedly, and
the selecting whether the setting data for the upper hierarchy is handed over can be changed.

4. The information processing apparatus according to claim 2, wherein the parameter setting unit further
displays the setting screen on which the selection icon that for selecting whether the setting data for the upper hierarchy is handed over for each predetermined item; and
saves, in the second storage unit, the setting data for the lower hierarchy deterministically input by the user and information indicating whether the setting data for the upper hierarchy is handed over for each predetermined item.

5. The information processing apparatus according to claim 2, wherein the flow-execution control unit when the communication unit receives an execution command for delivery data and a project flow,
reads project flow data of the project flow from the first storage unit;
by using an identifier of setting data associated with each of processes constituting the project flow data,
reads setting data corresponding to the identifier from the second storage unit;
for an item in which inheritance of the setting data for the upper hierarchy is described with respect to the read setting data,
creates latest setting data by using setting data for an upper hierarchy than that of the read setting data as setting data of the item; and
controls execution of a process performed on the delivery data based on the project flow data and the latest setting data.

6. A delivery system comprising:
an information processing apparatus including
a first storage unit configured to store therein project flow data that contain an association of a flow of one or more processes performed on delivery data with an identifier for setting data for use in the processes;
a second storage unit configured to store therein contents of the setting data in a predetermined hierarchical structure;
a communication unit configured to control transmission and reception of the delivery data and other types of data;
a parameter setting unit configured to set and update contents of the setting data; and
a flow-execution control unit configured to control executions of the one or more processes performed on the delivery data based on the project flow data and the setting data, wherein
when setting setting data of a lower hierarchy than a most significant hierarchy, the parameter setting unit reads setting data for an upper hierarchy than the lower hierarchy from the second storage unit and hands over read setting data to the lower hierarchy for inheritance; and
an image forming apparatus that supplies the delivery data to the information processing apparatus, wherein
the information processing apparatus controls a delivery process to be performed on data received from the image forming apparatus.

7. A processing control method in an information processing apparatus that controls a delivery process in a delivery system that delivers delivery data,
the information processing apparatus comprising:
a first storage unit configured to store therein project flow data that contain an association of a flow of one or more processes performed on the delivery data with an identifier for setting data for use in the processes; and
a second storage unit configured to store therein contents of the setting data in a predetermined hierarchical structure,
the processing control method comprising:
upon detecting an operation for setting setting data of a lower hierarchy than a most significant hierarchy, reading setting data for an upper hierarchy than the lower hierarchy from the second storage unit and handing over read setting data to the lower hierarchy for inheritance.

8. The processing control method according to claim 7, wherein the reading and handing over include
displaying a setting screen on which the setting data for the upper hierarchy is displayed as a default value when the setting data for the upper hierarchy is handed over to the lower hierarchy and a selection icon for selecting whether the setting data for the upper hierarchy is handed over is displayed; and
saving, in the second storage unit, the setting data for the lower hierarchy and information indicating whether the setting data for the upper hierarchy is handed over when input is definitely determined by a user on the setting screen.

9. The processing control method according to claim 8, wherein
the selection icon can be operated repeatedly, and
the selecting whether the setting data for the upper hierarchy is handed over can be changed.

10. The processing control method according to claim 8, wherein
the displaying further includes displaying the setting screen on which the selection icon that for selecting whether the setting data for the upper hierarchy is handed over for each predetermined item; and
the saving further includes saving, in the second storage unit, the setting data for the lower hierarchy deterministically input by the user and information indicating whether the setting data for the upper hierarchy is handed over for each predetermined item.

11. The processing control method according to claim 8, wherein, upon receiving an execution command for delivery data and a project flow, the processing control method further includes
reading project flow data of the project flow from the first storage unit;
by using an identifier of setting data associated with each of processes constituting the project flow data, reading setting data corresponding to the identifier from the second storage unit;
for an item in which inheritance of the setting data for the upper hierarchy is described with respect to the read setting data, creating latest setting data by using setting data for an upper hierarchy than that of the read setting data as setting data of the item; and
controlling execution of a process performed on the delivery data based on the project flow data and the latest setting data.
